(19) United States
(12) Patent Application Publication
(10) Pub. No.: US 2013/0067351 A1
(43) Pub. Date: Mar. 14, 2013

(54) PERFORMANCE MANAGEMENT SYSTEM USING PERFORMANCE FEEDBACK POOL

(71) Applicants: Yumiko Christine Yokoi, San Francisco, CA (US); Nancy V. Lang, Palatine, IL (US); Justin Craig Field, Bellevue Hill (AU); Andrew Philip Gillibrand, Berkshire (GB); Hiteshbhai D. Shah, San Mateo, CA (US); Steven K. Chu, San Ramon, CA (US)

(72) Inventors: Yumiko Christine Yokoi, San Francisco, CA (US); Nancy V. Lang, Palatine, IL (US); Justin Craig Field, Bellevue Hill (AU); Andrew Philip Gillibrand, Berkshire (GB); Hiteshbhai D. Shah, San Mateo, CA (US); Steven K. Chu, San Ramon, CA (US)

(73) Assignee: Oracle International Corporation, Redwood Shores, CA (US)

(21) Appl. No.: 13/407,342

(22) Filed: Feb. 28, 2012

Related U.S. Application Data
(63) Continuation-in-part of application No. 13/149,568, filed on May 31, 2011.

(51) Int. Cl. G06F 3/048; G06F 17/30; G06F 15/16

(52) U.S. Cl. 715/752

(57) ABSTRACT

A system and method for designating or tagging an electronic message, such as an email that includes feedback about an employee's performance. The tagged email can then be automatically embedded within, or otherwise associated with, a performance management document such as a performance review. An example method includes providing a user interface display screen, whereby a user may view contents of an electronic message; providing a first user option, in association with the user interface display screen, to selectively designate the electronic message for a predetermined purpose and providing a signal in response thereto; and associating the electronic message with a document in response to the signal in accordance with a designation of the electronic message. In a specific embodiment, the designation of the electronic message includes a feedback designation, such that the electronic message is designated as a feedback message. The feedback message represents unsolicited feedback.

### CROSS REFERENCES TO RELATED APPLICATIONS

This application is a continuation-in-part of the following application, U.S. patent application Ser. No. 13/149,568, Attorney Docket No. ORACP0046 (ORA110295-US-NP), entitled PERFORMANCE MANAGEMENT SYSTEM USING UNSOLICITED FEEDBACK, filed on May 31, 2011, which is hereby incorporated by reference, as if set forth in full in this specification for all purposes.

### BACKGROUND

The present application relates to software and more specifically to communications applications that facilitate diverting, tagging, or otherwise associating messages for predetermined purposes.

Systems and methods for handling electronic communications messages are employed in various demanding applications, including client software for receiving and filtering Short Message Service (SMS) text messages, Internet Relay Chat (IRC) messages, conventional email messages, and so on. Such applications often demand feature rich clients with tools for effectively filtering, filing, or otherwise handling messages.

Efficient mechanisms for effectively filtering or filing messages are particularly important in enterprise implementations, where each message may be relevant to a particular business operation, process, task, goal, and so on. Methods for effectively organizing incoming messages may facilitate certain enterprise tasks that are related to incoming or outgoing messages.

Conventionally, messaging clients, such as Microsoft Outlook Express, may provide features or tools for filtering messages or filing messages in particular folders. However, such applications typically lack more in depth features for facilitating organizing messages for use by other enterprise processes, documents, and so on.

Methods for handling messages pertaining to enterprise-personnel performance feedback can be particularly useful for enterprises that periodically rate enterprise personnel based, in part, on feedback associated therewith. Conventionally, received email messages, which may constitute feedback, are maintained in an email client folder. During a performance review, access to the feedback may require time-consuming search of the client folder for relevant messages.

### SUMMARY

An example method for designating or tagging an electronic message includes providing a user interface display screen whereby a user may view contents of an electronic message; providing a first user option, in association with the user interface display screen, to selectively designate the electronic message for a predetermined purpose and providing a signal in response thereto; and associating the electronic message with a document in response to the signal in accordance with a designation of the electronic message.

In a more specific embodiment, the designation of the electronic message includes a feedback designation, such that the electronic message is designated as a feedback message. The feedback message may represent unsolicited feedback. The step of associating includes embedding the electronic message in a performance management document, which may include a performance review document. The performance review document may be associated with a recipient of feedback, i.e., the subject of the performance review document.

The example method further includes providing a second user option to select a portion of the particular electronic message and to designate the portion of the electronic message as feedback for association with the performance review document. A recipient or sender of an electronic message, such as an email message, may employ the user interface control to designate the electronic message or portion thereof as feedback to be automatically included in or linked to a performance evaluation document.

The novel design of certain embodiments discussed herein is facilitated by various mechanisms, such as user interface controls displayed in proximity to email messages, which allow unsolicited feedback to be associated with a performance evaluation document. Unsolicited feedback may be higher quality than solicited feedback. In general, unsolicited feedback may be more timely than solicited feedback, and it may more accurately represent a feedback giver's thoughts than if it were requested several months after the fact (during the performance evaluation cycle). Unsolicited feedback may generally be more authentic than solicited feedback, since the feedback is voluntary. Furthermore, certain embodiments discussed herein may reduce the need to sort through emails, print emails, and so on, in search of relevant feedback for inclusion in a performance evaluation document.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of a first example embodiment of a system for facilitating associating an electronic message with a performance review document for an enterprise employee or other personnel.

FIG. 2 is a diagram of a first example user interface display screen of an email client that is adapted for use with the system of FIG. 1 and includes user interface controls for associating email with a performance review document for inclusion as feedback therein.

FIG. 3 is a diagram of a second example user interface screen of an email client that is adapted for use with the system of FIG. 1 and includes user interface controls for associating incoming email with a performance review document for inclusion as feedback therein.

FIG. 4 is a diagram of a third example user interface display screen depicting an example performance review document, which includes feedback provided in response to user manipulation of the user interface display screens of FIGS. 2-3.

FIG. 5 is a flow diagram of first example method adapted for use with the embodiments of FIGS. 1-4.

FIG. 6 is a flow diagram of a second example method adapted for use with the embodiments of FIGS. 1-4.

FIG. 7 is a diagram of a fourth example user interface display screen for facilitating searching for feedback positioned in one or more performance evaluations documents or feedback pools.

FIG. 8 is a diagram of a fifth example user interface display screen for facilitating viewing feedback search results and performing various operations pertaining to retrieved feedback.

### DETAILED DESCRIPTION OF EMBODIMENTS

Although the description has been described with respect to particular embodiments thereof, these particular embodiments are merely illustrative, and not restrictive.

For example, while embodiments are discussed herein with respect to methods and accompanying user interfaces for selectively allocating email messages as feedback to be included in an enterprise employee performance evaluation document, embodiments are not limited thereto. For example, any electronic message, such as a text message, Internet blog entry, and so on, may be automatically tagged or associated with a particular type of content and then automatically incorporated into or linked with virtually any type of document, without departing from the scope of the present teachings.

Furthermore, while embodiments are discussed herein with respect to an enterprise application pertaining to performance management, embodiments are not limited thereto. For example, content organization and linking methods discussed herein may be employed in various applications other than enterprise applications, where improved ability to organize content in a document or user interface is desired.

For the purposes of the present discussion, an enterprise may be any organization of persons, such as a business, university, government, military, and so on. The terms “organization” and “enterprise” are employed interchangeably herein. Personnel of an organization or enterprise, i.e., enterprise personnel, may include any persons associated with the organization, such as employees, contractors, board members, and so on. The terms “employee” or “employees” and “enterprise personnel” are employed interchangeably herein. For example, an enterprise employee, or simply employee, may be any person associated with an organization, such as a worker, manager, executive, contractor, or other person who may be subject to being rated via a performance document.

For the purposes of the present discussion, a document may be any collection of information, which may include one or more virtual files (as opposed to a printed hard copy of a file) and/or computing objects. A document need not be represented as a single file, but may include, for example, files linked together and accessible via a common interface, such as via an HyperText Markup Language (HTML) web page or file or via an eXtensible Markup Language (XML) page or file. A performance review document, also called a performance evaluation document or performance report, may be any document that is adapted to specifically contain or reference information pertaining to the performance and/or behavior of an employee or other enterprise personnel over a predetermined time interval. Hence, contents of a particular performance review document may be implemented via one or more database files, document file, HTML file, etc. Information in a particular performance review document may be located in a single file or distributed among different locations in a network. For example, in certain implementations, a performance review document may be considered to include content that is linked to a particular webpage or user interface display screen or is otherwise readily accessible thereby.

For the purposes of the present discussion, feedback is considered to be a type of information, which includes any information or input regarding the performance of one or more tasks, behaviors, and so on. Feedback may include, for example, advice given to a person (e.g., employee) pertaining to a particular task, comments pertaining to a particular competency, input pertaining to tasks associated with a certain goal, advice pertaining to future or past performance, goals, aspirations, and so on.

A feedback message may be any message, such as an electronic message, which includes feedback information, or which is otherwise designated as constituting feedback. Hence, a feedback message may include advice, criticism, praise, instruction, and/or other input pertaining to a task, behavior, or other activity performed by a recipient of the feedback. For example, a manager may send a feedback message to a subordinate employee praising the employee for success in achieving a particular goal with in a predetermined time interval. A mentor may provide an instructional feedback message commenting as to how a particular mentee may improve performance pertaining to a particular task, and so on.

Unsolicited feedback may be any feedback that is not provided in direct response to a specific request for feedback. Note that conventionally, enterprise systems for managing feedback typically only categorize or organize feedback that is generated in response to a specific request made by a feedback recipient. Generally, enterprise systems lack effective mechanisms for managing or organizing feedback that is not made in response to a specific feedback request made via special feedback applications and user interfaces.

An electronic message may be any communication sent or stored electronically, such as via a computer. A communication may be any portion of information, such as a note, document, and so on. Examples of electronic messages include emails and/or associated attachments or portions thereof, text messages, instant messages sent via Internet Relay Chat (IRC), and so on.

For clarity, certain well-known components, such as hard drives, processors, operating systems, power supplies, and so on, have been omitted from the figures. However, those skilled in the art with access to the present teachings will know which components to implement and how to implement them to meet the needs of a given application.

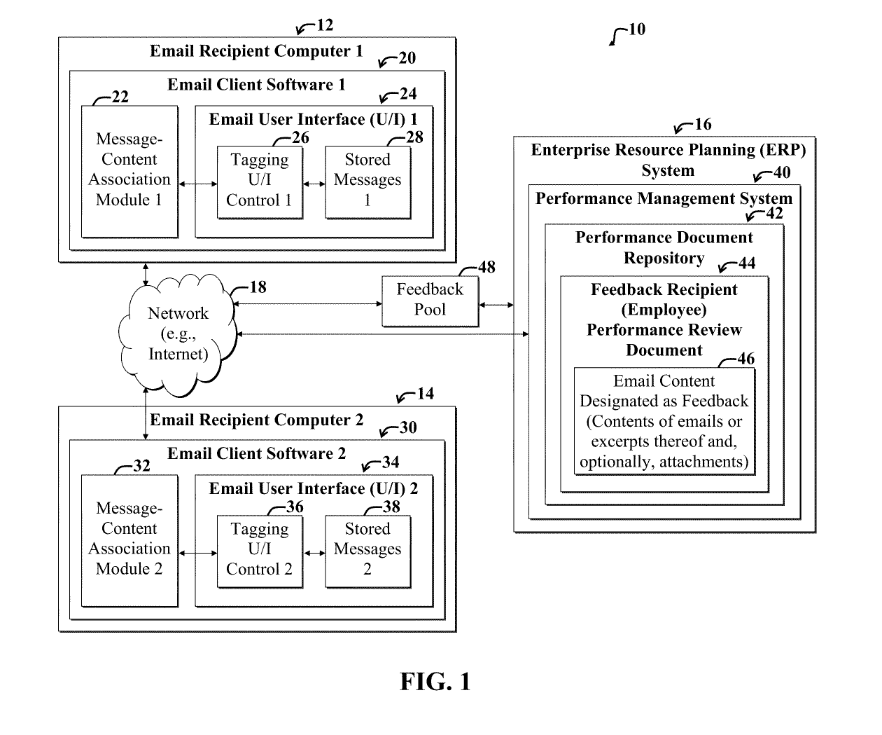

FIG. 1 is a diagram of a first example embodiment of a system 110 for facilitating associating an electronic message with a performance review document 44 for an enterprise employee or other personnel. The example system 10 includes a first email recipient computer 12 and a second email recipient computer 14 in communication with an Enterprise Resource Planning (ERP) system 16 via a network 18, such as the Internet.

The first example email recipient computer 12 runs a first instance of email client software 20, such as a modified version of Outlook, Web Mail, etc. The email client software 20 includes a message-content association module 22 in communication with a first email client user interface module 24. The first email client user interface 24 includes a first tagging user interface control module 26, which displays associated user interface controls when email messages 28 are displayed via the first user interface module 24.

The second email recipient computer 14 includes various modules 30-38, which are arranged and operate similarly to the modules 20-28 of the first email recipient computer, respectively.

The example ERP system 16 includes a performance management system 40, which includes a performance document repository 42. The performance document repository 42, also called an employee evaluation document repository, includes an example performance review document 44, also called a performance evaluation document, performance report, or performance document. The example performance review document 44 includes a collection of email content 46, which has been collected from emails sent and/or received by enterprise personnel using email clients, such as the client computers 12, 14, to send and/or receive emails. The collected email content 46 has been marked (also called designated) as feedback by recipients or senders of the email messages and associated content.

Similarly, an example feedback pool module 48, may include a collection of email content or other data that has been designated as feedback. The feedback pool 48 may represent a store of all designated feedback for each employee, which has been received during past performance evaluation periods.

The feedback pool 48 may communicate with the email clients 12, 14 via the network 18, and may be implemented as part of the performance management system 40. In certain implementations, the feedback pool 48 is populated via email client software 20, 30 directing designated feedback to the feedback pool 48 and to the performance review document 44. Alternatively, computer code for enabling the feedback pool 48 to collect feedback from plural past performance review documents maintained by the performance document repository 42 may be included in the feedback pool 48.

Note that functionality represented by the feedback pool module 48 may be integrated into the performance document repository 44 without departing from the scope of the present teachings. For example, in such an implementation, various past and current performance review documents pertaining to a particular employee may be searched for particular instances of feedback as though it were a single document or collection of feedback.

In general, use of a feedback pool as discussed herein may enable employees, managers, or other feedback givers to search for feedback using various search criteria, such as date range, keyword search, feedback giver name and feedback giver role, thereby making feedback more readily accessible to the user, as discussed more fully below. Furthermore, use of the feedback pool may facilitate displaying feedback from multiple performance evaluation periods. This may facilitate ascertaining employee progress between performance evaluation cycles and may further facilitate determining areas for improvement.

For the purposes of the present discussion, a feedback pool may be any collection of feedback or documents containing feedback. The message content association modules 22, 32 may include additional functionality for enabling users of the client computers 12, 14 to perform various search operations to locate particular instances of feedback in the repository 42 and/or in the feedback pool 48. Note that the performance evaluation document repository 42 may include additional files or databases that contain feedback. For example, the feedback pool 48 may be incorporated into the performance document repository 42 without departing from the scope of the present teachings.

The feedback may have been extracted from the performance evaluation documents 44 or populated with feedback via another mechanism(s), e.g., mechanisms implemented via the message-content association modules 22, 32. In the present example embodiment, the message-content association modules 22, 32 are adapted to also populate (in addition to one or more performance evaluation documents 44) the feedback pool file or database 48. In addition, the client computers 12, 14 may include additional user interface modules and/or functionality for facilitating implementing searches for instances of feedback among the feedback repository 40.

In an example operative scenario, a user (called the first user) of the first email client computer 12 opens one of the stored email messages 28 via the first email user interface 24. A tagging user interface control, such as a button, is generated for display by the first tagging user interface control module 26. The tagging user interface control is displayed near the resulting displayed email message. The user then selects the tagging user interface control, as discussed more fully below, to activate additional user interface controls via the first tagging user interface control module 26.

The additional user interface controls are adapted to enable the first user to designate the opened (or otherwise selected) email message as a feedback message. When the user designates the email message as a feedback message, a resulting signal activates first the message-content association module 22, which lodges a copy of the email message, or selected portion thereof, in the performance review document 44 among the email content 46 and in the feedback pool 48. The email content 46 is also simply called feedback or notes derived from email.

The email user interfaces 24, 34 may include computer code for providing one or more user options for identifying a preexisting performance review document for which to associate designated feedback (e.g., email content 46). In addition, a user may employ the email user interfaces 24, 34 to describe or specify a future (not yet created) performance review document for which to associate email content. When a performance review document matching the description is later created, the resulting performance review document may be automatically adjusted to included designated feedback (e.g., email content 46). In addition, the email user interfaces 24, 34 may provide user options for triggering creation of a performance review document (for which to associate email content) in accordance with user-specified parameters. Alternatively, selection of preexisting or future performance review document(s) for associating with email content is automatically performed via predetermined computer code running on the message-content association module 22, 32. Hence, the association of email content (e.g., feedback) with a performance review document does not require a preexisting performance review document. Feedback can be associated with one or more future performance review documents, i.e., “future” associations can be created or specified.

Note that in certain embodiments, a user may simultaneously select multiple email messages for association with the performance review document 44. In addition, user interface controls generated by the first tagging user interface control module 26 may include additional controls for enabling a user to supply additional tags to an email message, which may facilitate searching for, organizing, or otherwise handling email content. Those skilled in the art will appreciate that the designation or tagging of particular email content may be implemented via metadata, and XML may be used to link functionality between the ERP system 16 and the client computers 12, 14 via the network 18.

In the present example operative scenario, the stored email message opened by the first user of the first email recipient computer 12 represents an email message that has been received by the first user and which contains feedback pertaining to the first user. In this case, first user (or performance thereof) is the subject of the performance review document 44. Alternatively, the selected email message may be an outgoing message to be sent by the first user to a second user of the second email recipient computer 14, where the email content includes feedback pertaining to the second user. Alternatively, the selected email message represents an email either to be sent to the second user or which has been received by the first user from the second user, but pertains to feedback given to a third user (not shown), who is the subject of the performance review document 44. Hence, the feedback in a given email message need not pertain to a particular sender or recipient of the email message.

Hence, an email may be designated as feedback by a sender as pertaining to a given recipient; by a recipient pertaining to the recipient; or by a recipient or sender pertaining to a third party, where the third party is other than the sender or recipient of the email message being designated as feedback for inclusion in the performance review document 44. In addition, designation of an email message as feedback involves assigning or otherwise associating an entire message or a portion thereof as feedback via one or more user interface controls generated via the first tagging user interface control module 26 and accompanying message-content association module 22.

In summary, after designation as feedback, the message-content association module 22 copies selected email content comprising feedback into the performance review document 46. The content is said to be embedded in and associated with the performance review document 44 pertaining to an employee feedback recipient who is subject of the performance review document 44.

Note that conventionally, viewers of performance review documents are limited to only viewing feedback one performance evaluation document at a time. They typically cannot, for example, search for or view consolidated feedback for a given timeframe or for a competency or feedback given by a specific person. Such options are afforded via the email user interfaces 24, 34, message-content association modules 22, 32, feedback pool 48, and performance document repository 40, which may implement the feedback repository.

Hence, use of a feedback repository or pool, as discussed herein regarding the alternative operative scenario, facilitates enabling accessing instances of feedback using various different search options. Access to a feedback repository or pool also facilitates allowing a manager and feedback giver to readily re-use (copy/paste) previously given feedback for a subsequent performance evaluation period or cycle.

Those skilled in the art with access to the present teachings may readily implement the various modules 20-28 of the email client software 20, such as via plug-ins or add-ons, without undue experimentation.

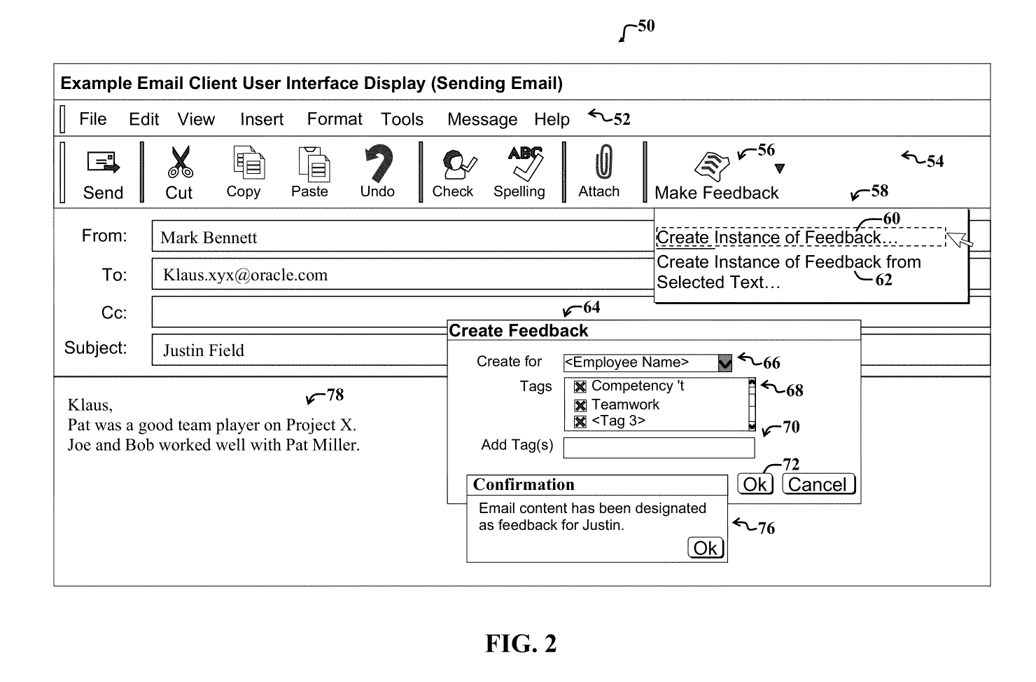

FIG. 2 is a diagram of a first example user interface display screen 50 of an example email client that is adapted for use with the system 10 of FIG. 1 and includes user interface controls 56-76 for associating an outgoing email message 78 with a performance review document, such as the document 44 of FIG. 1, for inclusion as feedback therein.

The example user interface display screen includes a menu bar 52 with various standard menus, e.g., file, edit, view, insert, format, tools, and so on. A tool bar with various button icons 54 is positioned below the menu bar 52. In general, the user interface display screen 50 may be implemented via a conventional email client, such as via Microsoft Outlook Express, which has been adjusted to include functionality corresponding to the make-feedback button 56 and associated drop-down menu 58 and dialog boxes 64, 76.

The present example user interface display screen 50 represents an email written by and being sent from a first employee (Mark Bennett) to a second employee (Klaus). Email content 78 discusses a third employee (Pat Miller), who is subject to a performance evaluation process.

In the present example operative scenario, the first employee, Mark Bennett decides to mark the outgoing email content 78 to be sent to the second employee, Klaus, as feedback pertaining to Pat Miller. Accordingly, the user Mark selects the make-feedback button icon 56, which then activates a corresponding drop-down menu 60. The example drop-down menu 60 includes various selectable options, including a first option 60 to designate all of the email content 78 as feedback. A second option 62 enables the user Mark to selectively designate a portion of the email content 78 as feedback by first highlighting a particular portion of the email content 78, and then selecting the second user option from the drop-down menu 62. Note that alternatively, Mark could choose a previously sent email (for feedback designation) as opposed to an outgoing email (i.e., email to be sent).

Upon selection of the first option 60 or the second option 62 from the make-feedback drop-down menu 58, a create-feedback dialog box 64 appears. For the purposes of the present discussion, a dialog box may be any computer-generated graphical representation that includes one or more displayed mechanisms that are responsive to user input.

The create-feedback dialog box 64 includes a drop-down menu 66 enabling a user to select, i.e., designate, which employee (e.g., Pat Miller) the feedback will pertain to. Additional tags may be associated with the content via selection of one or more tags from a list of tags 68. Additional tags, such as labels, may be associated with the email content 78. The tags may facilitate search operations for particular content, e.g., content occurring in a performance review document.

Examples of tags include competency and teamwork tags. Such tags may facilitate organizing a feedback message within a performance review document in accordance with the tags. When an email message or portion thereof is designated as a feedback message in combination with one or more tags being applied thereto, the email message or portion thereof is said to be assigned multiple designations. For example, the selected email content 96 is designated as not only being feedback but as pertaining to competency and teamwork.

A user may enter additional tags (and then press an enter key or the Ok button 72) in an add-tags field 70. Upon selecting the Ok button 72, an optional confirmation dialog box 76 appears. In the present example scenario, the additional dialog box 76 confirms to the user Mark Bennett that the email content 78 has been designated as feedback pertaining to Pat Miller for inclusion in a performance evaluation document pertaining to a performance review of Pat Miller and his past performance while working at a particular enterprise.

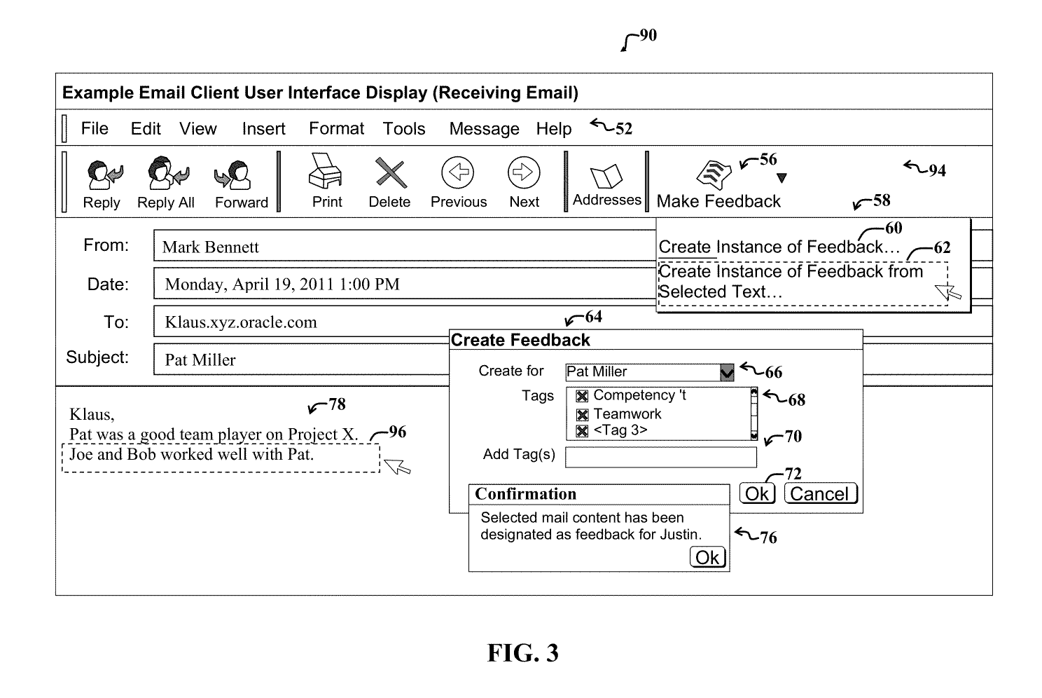

FIG. 3 is a diagram of a second example user interface screen 90 of an email client that is adapted for use with the system 10 of FIG. 1 and includes user interface controls 56-76 for associating content from incoming email message 78 with a performance review document for inclusion as feedback therein.

The construction and operation of the second example user interface display screen 90 is similar to the construction and operation of the first example user interface display screen 50 of FIG. 2 with the exception that the second user interface display screen is adapted to display a received email message as opposed to facilitate constructing an outgoing email message. For example, the set of button icons 94 displayed and accessible via the second user interface display screen 52 are different than the set of buttons and icons 54 of the first user interface display screen 50 of FIG. 2, with the exception of the make-feedback button icon 56 and associated user interface controls 58-76.

In the present example operative scenario, Klaus has received email content 78 from Mark Bennett, a portion 96 of which is considered, by Klaus, to constitute feedback pertaining to Pat Miller. Klaus selects the portion 96, such as by highlighting the portion 96, and then subsequently selects the make-feedback button icon 56 to activate the accompanying drop-down menu 58. Klaus then selects the second option 62 from the drop-down menu to associate the portion 96 (as opposed to the entire email message content 78) with Pat Miller's performance review document and for inclusion as feedback therein. The selected portion 96 is said to represent an instance of feedback or portion thereof.

Hence, the email content 78 s being opened and read by Klaus, who has decided to designate the particular portion 96 of Mark Bennett's email 78 as feedback to be included in a performance review document associated with Pat Miller.

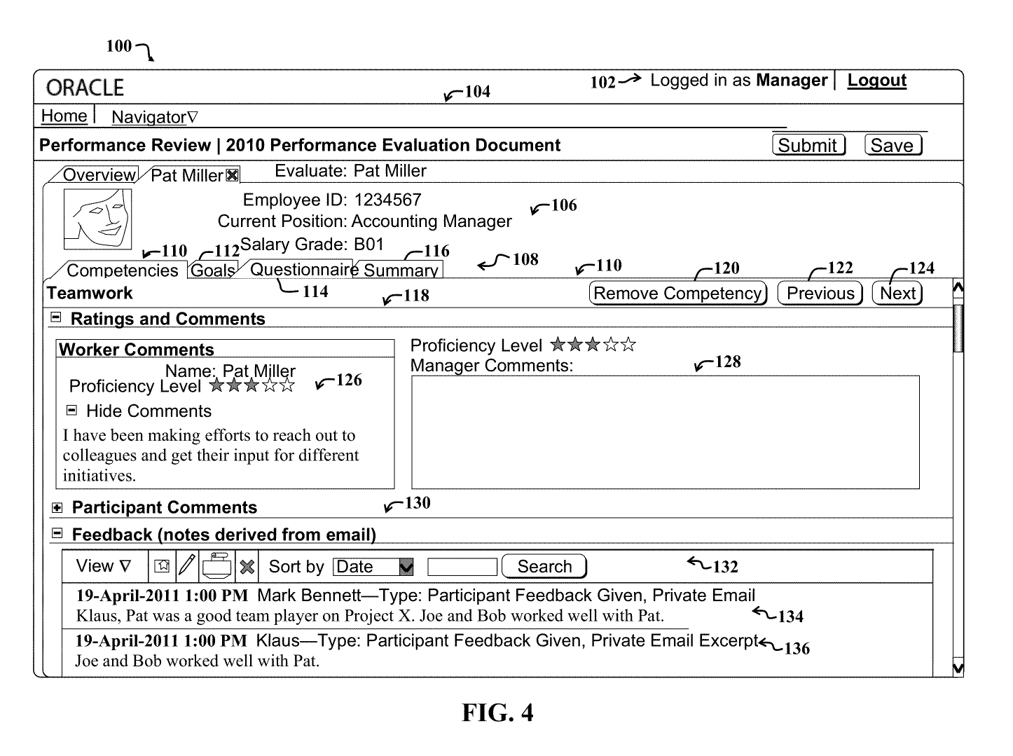

FIG. 4 is a diagram of a third example user interface display screen 100 depicting an example performance review document 104, which includes feedback 134, 136 provided in response to user manipulation of the user interface display screens of FIGS. 2-3.

In the present example embodiment, third example user interface display screen 100 is used by a manager (e.g., as indicated via a login information section 102) to review and/or edit Pat Miller's performance evaluation (also called performance review) document 104. Note that while the person viewing the performance evaluation document 104 is indicated as “Manager,” the manager may be Klaus or another person with permissions or access privileges to view the document 104. The document 104 includes employee-identification information 106, which is positioned above various tabs 108 corresponding to different sections of the performance review document 104.

The tabs include a goals tab 112, a questionnaire tab 114, a summary tab 116, and the currently shown competencies tab 110. The competencies tab 110 includes user interface controls 120-124 for removing a particular competency, such as teamwork; for shifting the display to a subsequent competency, e.g., via a next button 124, or shifting the display to a previous competency, e.g., via a previous button 122.

The competencies tab 110 currently shows a teamwork sub-section 118, wherein teamwork represents a particular competency. Competency represents an information category, which in the present example embodiment, corresponds to one of the tags 68 of FIGS. 2-3, which were applied to the email content that was designated as feedback.

The teamwork sub-section 118 includes a worker-comment section 126 for displaying comments or statements by the person (Pat Miller) who is subject of the performance evaluation document 104. A manager-comment section 128 provides user interface controls for enabling a manager to make comments pertaining to the reviewed employee (Pat Miller). A feedback section 130 includes a band of user interface controls 132, which are adapted to enable a manager to perform various actions, such as searches on feedback content 134, 136 included in the feedback section 130. The controls 132 are also adapted to enable a manager or other authorized reviewer to sort, print, and edit feedback content. Note that user-created tags that have been assigned to particular feedback may be entered as search terms in a search field of the controls 132. However, search functionality provided by the controls 132 is not limited to searching based on tags, but may enable searching for terms present in the feedback or other characteristics of the feedback, such as when the feedback was created.

The feedback content 134, 136 includes email messages or excerpts thereof, which have been designated as feedback via one or more of the embodiments of FIGS. 1-3.

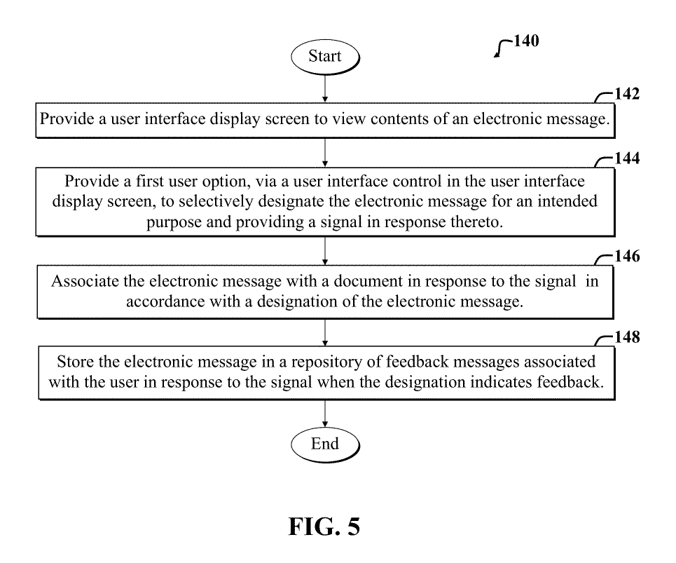

FIG. 5 is a flow diagram of first example method 140 adapted for use with the embodiments of FIGS. 1-4. The example method 140 represents a method for method for designating or tagging an electronic message. The example method includes a first step 142, which includes providing a user interface display screen whereby a user may view contents of an electronic message, such as an email message.

A second step 144 includes providing a first user option, in association with the user interface display screen, to selectively designate the electronic message for an intended purpose and providing a signal in response thereto. A user option is said to be “in association with” a user interface display screen if one or more user interface controls providing the user option are displayed concurrently with or are otherwise made accessible via the user interface display screen.

A third step 146 includes associating the electronic message with a document in response to the signal in accordance with a designation of the electronic message.

A fourth step 148 includes storing the electronic message in a repository of feedback messages, i.e., feedback pool, associated with the user in response to the signal when the designation indicates feedback.

Various methods disclosed herein, including the method 140, may be modified, such as by adding, removing, repositioning, or modifying one or more steps, without departing from the scope of the present teachings For example, the third step 146 may be omitted or interchanged with the fourth step 148. Examples of an additional step, which may be added to the method 140, include providing a second user option to initiate a search of the repository for a feedback message based on search criteria; and displaying results of a search of the repository in proximity to one or more user interface controls for specifying search criteria for initiating a search of the repository.

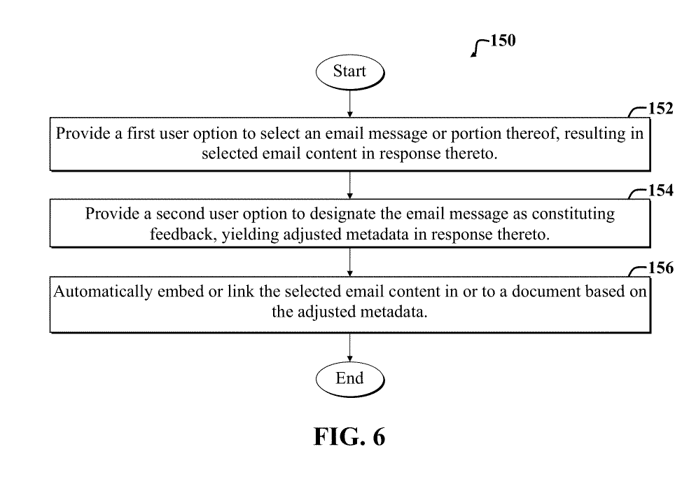

FIG. 6 is a flow diagram of a second example method 150 adapted for use with the embodiments of FIGS. 1-4. The method 150 represents a method for adjusting metadata associated with email content. The example method includes an initial selection step 152, which includes providing a first user option to select an email message or portion thereof, resulting in selected email content in response thereto.

A subsequent designating step 154 includes providing a second user option to designate the email message as constituting feedback, yielding adjusted metadata in response thereto.

Next, a linking step 156 includes automatically embedding or linking the selected email content in or to a document based on the adjusted metadata.

Hence, certain embodiment disclosed herein may enable employees and managers to take advantage of naturally occurring day-to-day feedback that is frequently provided by others as part of the normal course of business. In the course of daily work, people are often sending feedback to one another concerning work in the form of emails giving praise, or thanking someone for their support on an issue, or conveying that they should have taken a different approach to a problem, or suggesting that they (for example) do a better job at managing their time.

With certain embodiments discussed herein, users can take this unsolicited feedback that they receive via email on a day-to-day basis and easily designate it to be considered as performance feedback. Based on this designation, the underlying system will associate the email feedback to the user's performance evaluation document. At the time of the performance evaluation cycle, the user will have full access to the different feedback that s/he received throughout the year from various people, right in the performance document user interface. Thus the user can easily refer to the feedback while reflecting on her/his accomplishments during the year without additional effort.

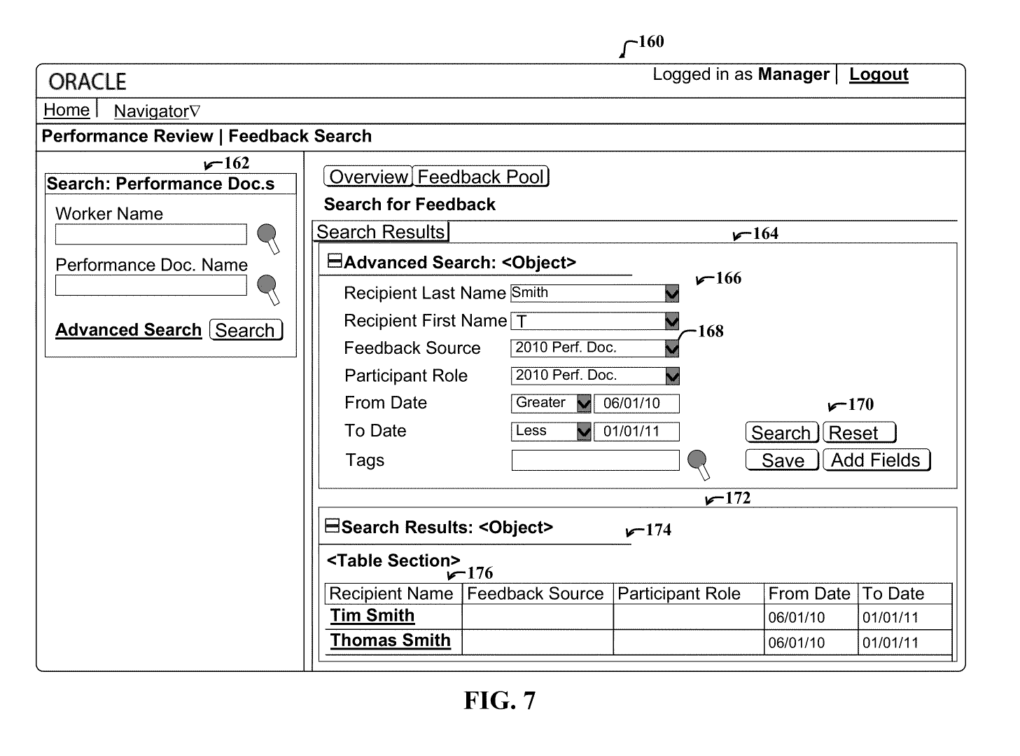

FIG. 7 is a diagram of a fourth example user interface display screen 160 for facilitating searching for feedback positioned in one or more feedback pools or performance evaluations documents. Graphical user interface code for implementing the display screen 160 may be implemented via the client software 20, 30 of FIG. 1 and/or via one or more applications of the ERP system 16 of FIG. 10.

The fourth example user interface display screen 160 includes a basic search section 162, which includes fields for entering search criteria. Example search criteria fields include a field to enter name of an employee or worker associated with the feedback sought, and a performance document name field for identifying any particular performance evaluation document that should be searched. The search section 162 includes a search button for initiating a search based on entered search criteria, and an advanced search link for activating functionality for implementing an advanced search, which may be accessed via an advanced search section 164.

The advanced search section 164 includes various search criteria fields 166 for entering detailed search criteria, such as feedback recipient last name, first name, feedback participant role, dates or date ranges associated with the feedback sought, feedback tag information, and so on. In addition, the search criteria fields 166 include a feedback source drop-down menu 168 for selecting a particular feedback source to search. Examples of feedback sources include particular performance evaluation documents, feedback pools, feedback stored via other feedback tracking applications, and so on. Exact details of available feedback sources are implementation specific and may vary depending upon the requirements of a particular implementation. The advanced search section 164 further includes various buttons 170 for initiating a search based on entered criteria, resetting the search criteria, saving the search criteria, and adding additional fields to the search criteria fields 166.

After activation of a search for feedback, such as via the basic search section 162 or via the advanced search section 164, search results may be displayed in table format, e.g., in a search results section 172. The search results section 172 includes a feedback table 174, which lists feedback recipients 176 who are associated with feedback matching entered search criteria. The feedback recipients 176 may be identified by name along with information about retrieved feedback, such as feedback source, feedback participant role, feedback date ranges, and so on.

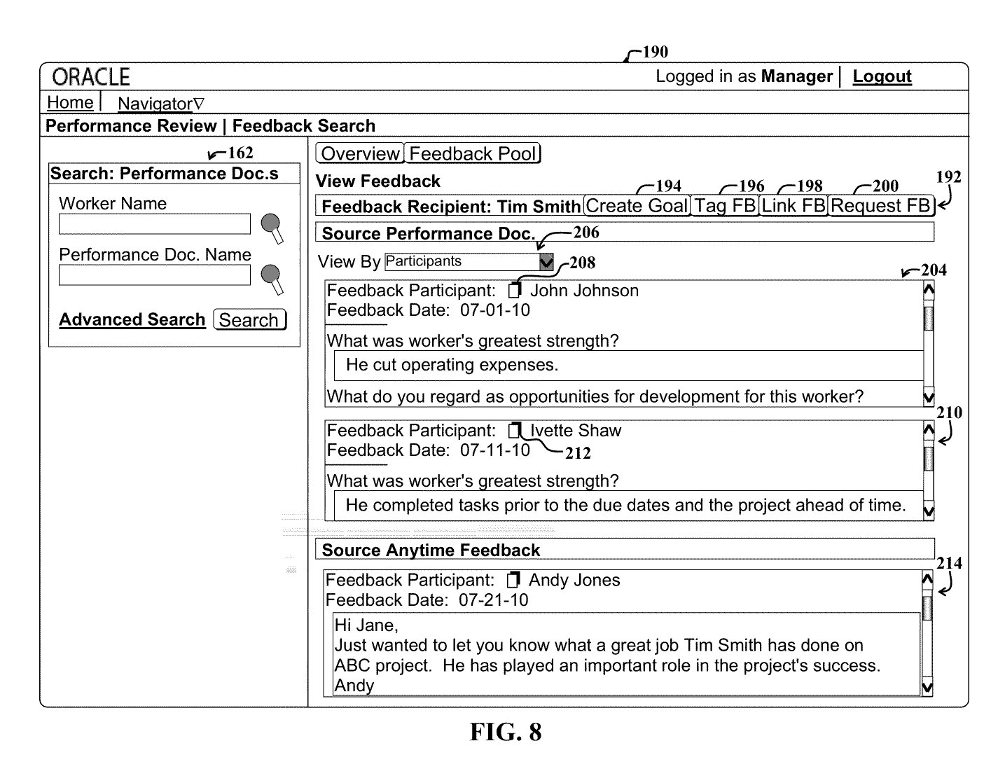

In the present example embodiment, names of feedback recipients 176 are hyperlinked such that upon selection of a feedback recipient name, a subsequent user interface display screen, called a feedback pool user interface display screen, is shown, as discussed more fully below with reference to FIG. 8. The resulting feedback pool user interface display screen illustrates feedback associated with the indicated feedback recipient, which includes feedback matching search criteria entered in the search criteria fields 166 or in the basic search section 162.

FIG. 8 is a diagram of a fifth example user interface display screen 190 for facilitating viewing feedback search results and performing various operations pertaining to retrieved feedback. The fifth example user interface display screen 190 represents a feedback pool user interface display screen, since various user interface controls therein may be used to view and manipulate feedback from various sources, which are said to comprise a feedback pool. The fifth example user interface display screen 190 includes various user interface controls for enabling a user to tag feedback, link feedback to a goal or other computing object, request feedback, contact feedback participants, list feedback by participant or other sorting criterion, and so on, as discussed more fully below.

The user interface display screen 190 includes a tool bar 192 indicating a name of the recipient of feedback indicated in the user interface display screen 190. In the present example operative scenario, a user has selected the hyperlinked name “Tim Smith” from among the listed recipients 176 in the search results table 174 of FIG. 7.

The tool bar 192 further includes a goal-creation button 194, a tag-feedback button 196, a link-feedback button 198, and a request-feedback button 200. The goal-creation button 194 provides a user option to create a goal in response to selection thereof. Selection of the goal-creation button 194 may trigger display of another user interface display screen with user interface controls for naming, describing, associating the goal with particular instances of feedback, and/or otherwise characterizing the goal.

The tag-feedback button 196 provides a user option to tag particular instances of feedback displayed in the user interface display screen 190. For example, a user may select feedback, such as feedback listed in one or more feedback sections 204, 210, 214, and then select the tag-feedback button 196. User selection of the tag-feedback button 196 may activate an additional user interface display screen with one or more user interface controls for naming, describing, or otherwise characterizing the feedback tag. In general, selection of feedback followed by selection of the tag-feedback button 196 will provide user options for tagging the selected feedback with a particular tag that is described or characterized by the user via a subsequently displayed tag-feedback user interface display screen.

Similarly, user selection of feedback (e.g., by highlighting feedback in one or more of the feedback sections 204, 210, 214) followed by user selection of the link-feedback button 198 will trigger display of additional user options for linking the selected feedback to one or more specified computing objects, such as goals, projects, participants, performance evaluation documents, and so on. Alternatively, a link-feedback user interface display screen that is displayed in response to user selection of the link-feedback button 198 may include additional user interface controls for enabling a user to specify particular instances of feedback to link (as opposed to the user preselecting instances of feedback prior to selection of the link-feedback button 198).

Similarly, a user may highlight or otherwise select a particular feedback participant named in the feedback sections 204, 210, 214, and then select the request-feedback button 200. User selection of the request-feedback button 200 may activate an additional user interface displays screen with controls for entering a feedback request to be sent to preselected feedback recipients. Alternatively, a user may select a communications control 208, 212 from the first feedback section 204 or second feedback section 210, which is positioned adjacent to a name of a feedback participant. Selection of a particular communications control 208, 212 may activate communications functionality, such as an email client, Instant Messaging (IM) client, etc., whereby a user may enter a message or other communication to be sent to the feedback participant listed adjacent to the selected communications control 208, 212.

The first example feedback section 204 includes various instances of feedback, which represent answers provided by feedback participant John Johnson in response to particular questions. Similarly, the second example feedback section 210 includes instances of feedback representing answers provided by Yvette Shaw in response to particular questions. The feedback provided in the first section 204 and section 210 are derived from one or more performance evaluation documents, as indicated in a header bar corresponding to the sections 204, 210. The questions shown are examples only and may vary depending upon a particular implementation.

The third feedback section 214 includes so-called anytime feedback, which may include unsolicited feedback extracted from an email or other communication. The feedback extraction may be performed by one or more software applications, which communicate with or be implemented via the system 10 of FIG. 1, for tracking, collecting, or lodging feedback. In the present example, the anytime feedback provided in the third feedback section 214 represents feedback provided by feedback participant Andy Jones to Jane pertaining to Tim Smith.

Note that the various feedback sections 204, 210, 214 are merely illustrative and may include additional or different types of feedback from sources in addition to or other than performance evaluation documents and anytime feedback retrieval mechanisms, without departing from the scope of the present teachings. Furthermore, different, fewer, or additional user interface controls for accessing a pool or repository of feedback may be provided.

The fifth example user interface display screen 190 further includes the basic search window 162 to facilitate conducting searches in response to viewing of feedback provided in the various sections 204, 210, 214.

An example method adapted for the user interface display screens 160, 190 of FIGS. 7, 8 includes providing a first user option to enter search criteria pertaining to one or more instances of feedback and providing a signal in response thereto; conducting a search of a feedback repository, pool, or other collection of feedback in response to the signal and based on the search criteria; and returning results in response thereto.

In a more specific implementation of the method, the results include a listing of feedback recipients or participants associated with feedback matching the search criteria. The listing of feedback recipients is hyperlinked so that selection of an indicated feedback recipient results in display of a user interface display screen that is adapted to enable a user to view feedback associated with the selected recipient. The example method further includes providing additional user options, via the user interface display screen, for communicating with a feedback participant, creating a goal, tagging one or more instances of feedback, linking feedback to one or more computing objects, and requesting feedback from one or more feedback participants indicated in the user interface display screen.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for storing and processing an electronic message, wherein the electronic message includes a comment on an employee's workplace performance, the method comprising:
providing a user interface display on a display screen whereby a user may view contents of an electronic message;
providing a first user option, in association with the user interface display, to selectively designate the electronic message as a feedback message and providing a signal in response thereto; and
storing the electronic message in a repository of feedback messages associated with the user in response to the signal.

2. The method of claim 1, further including providing a second user option to initiate a search of the repository for a feedback message based on search criteria.

3. The method of claim 2, further including displaying results of a search of the repository in proximity to one or more user interface controls for specifying search criteria for initiating a search of the repository.

4. The method of claim 2, wherein the results includes a listing specifying one or more feedback participants who match the search criteria.

5. The method of claim 4, wherein the listing includes an indication of one or more persons who have received or given feedback that matches one or more of the search criteria.

6. The method of claim 2, wherein the search criteria includes feedback recipient name.

7. The method of claim 2, wherein the search criteria includes a specification of a tag.

8. The method of claim 2, wherein the search criteria includes a specification of a feedback repository in which to search for one or more feedback messages matching the search criteria.

9. The method of claim 1, wherein the search criteria includes a date range.

10. The method of claim 1, further including providing a user option to browse feedback associated with a person who matches the search criteria as a feedback recipient or participant.

11. The method of claim 10, further including displaying a list of feedback messages associated with a selected feedback participant.

12. The method of claim 11, further including displaying a list of feedback messages associated with a selected feedback participant, wherein the list of feedback messages is organized by feedback participant.

13. The method of claim 1, wherein the feedback message represents unsolicited feedback.

14. The method of claim 1, further including providing a user interface control that is adapted to enable a recipient of an electronic message to designate the electronic message or portion thereof as feedback.

15. The method of claim 1, further including providing a user interface mechanism for displaying content of a performance review document and providing a user option to search for one or more particular electronic messages that have been designated as feedback.

16. An apparatus comprising:
a digital processor coupled to a display screen and to a processor-readable storage device, wherein the processor-readable storage device includes one or more instructions executable by the digital processor to perform the following acts:
providing a user interface display on a display screen whereby a user may view contents of an electronic message;
providing a first user option, in association with the user interface display, to selectively designate the electronic message as a feedback message and providing a signal in response thereto; and
storing the electronic message in a repository of feedback messages associated with the user in response to the signal.

17. A processor-readable storage device including instructions executable by a digital processor, the processor-readable storage device including one or more instructions for:
providing a user interface display on a display screen whereby a user may view contents of an electronic message;
providing a first user option, in association with the user interface display, to selectively designate the electronic message as a feedback message and providing a signal in response thereto; and
storing the electronic message in a repository of feedback messages associated with the user in response to the signal.
